(19) United States
(12) Patent Application Publication
(10) Pub. No.: US 2024/0289289 A1
(43) Pub. Date: Aug. 29, 2024

(54) METHOD AND APPARATUS FOR DETERMINING MEASUREMENT RESULT OF MULTIPLE QUBITS, AND QUANTUM COMPUTER

(71) Applicant: Origin Quantum Computing Technology (Hefei) Co., Ltd, Hefei (CN)

(72) Inventors: Shuangsheng FANG, Hefei (CN); Weicheng KONG, Hefei (CN); Hanqing SHI, Hefei (CN)

(73) Assignee: Origin Quantum Computing Technology (Hefei) Co., Ltd, Hefei (CN)

(21) Appl. No.: 18/433,983

(22) Filed: Feb. 6, 2024

Related U.S. Application Data
(63) Continuation of application No. PCT/CN2022/140862, filed on Dec. 22, 2022.

(30) Foreign Application Priority Data
Dec. 27, 2021 (CN) 202111625730.7
Dec. 30, 2021 (CN) 202111680550.9

(51) Int. Cl. G06F 13/36; G06N 10/40

(52) U.S. Cl. CPC G06F 13/36; G06N 10/40; G06F 2213/40

(57) ABSTRACT

Disclosed are a method and an apparatus for determining a measurement result of multiple qubits, and a quantum computer. The method comprises: separately acquiring, based on a sequence number of each to-be-read qubit, a readout feedback signal of a data bus corresponding to the to-be-read qubit; acquiring quantum state information of each to-be-read qubit based on the corresponding readout feedback signal; separately acquiring a quantum state measurement value of each to-be-read qubit based on the corresponding quantum state information and a readout criterion of the to-be-read qubit; and determining a measurement result target value of to-be-read qubits based on an information weight and the quantum state measurement value of each to-be-read qubit.

### CROSS-REFERENCE TO RELATED APPLICATIONS

The present disclosure is a continuation of International Application No. PCT/CN2022/140862, filed on Dec. 22, 2022, which claims the priority to Chinese Patent Application No. 202111625730.7, filed on Dec. 27, 2021 and entitled “METHOD AND APPARATUS FOR DETERMINING MEASUREMENT RESULT OF MULTIPLE QUBITS, AND QUANTUM COMPUTER”, and Chinese Patent Application No. 202111680550.9, filed on Dec. 30, 2021 and entitled “METHOD AND APPARATUS FOR OPTIMIZING PARAMETER OF READOUT SIGNAL OF MULTIPLE QUBITS, AND QUANTUM COMPUTER”. All of the aforementioned patent applications are hereby incorporated by reference in their entireties.

### TECHNICAL FIELD

The present application belongs to the field of quantum measurement and control technologies, and in particular, to a method and an apparatus for determining a measurement result of multiple qubits, and a quantum computer.

### BACKGROUND

Qubit information refers to a quantum state of a qubit, and basic quantum states are state |0 [symbol] and state |1 [symbol] . After the qubit is operated, the quantum state of the qubit changes. In a quantum chip, after the quantum chip is executed, a quantum state of a qubit changes, and the change is an execution result of the quantum chip. The execution result is carried in a qubit readout signal (generally an analog signal) and sent out.

A process of rapidly measuring a quantum state of a qubit by using a qubit readout signal is a key work for reflecting execution performance of a quantum chip. High accuracy of a qubit measurement result is always an important index continuously pursued in the quantum computing industry. In conventional technologies, a relatively mature manner is determining the index by using a measurement result of a single qubit that is not affected by other qubits. However, a plurality of associated qubits have a more practical and extensive application prospect. For example, the application may include running a dual quantum logic gate by using two associated qubits or running a plurality of associated qubits by using a plurality of quantum logic gates. For another example, the application may include running a quantum computing task by using a plurality of associated qubits. In these examples, determination of measurement results of a plurality of associated qubits is of particular importance. Up to now, there is no relevant technique regarding a method for determining measurement results of a plurality of associated qubits. Therefore, how to implement measurement on a plurality of associated qubits and also ensure accuracy of measurement results is a problem to be solved urgently at present.

### SUMMARY

An objective of the present disclosure is to provide a method and an apparatus for determining a measurement result of multiple qubits, and a quantum computer, to solve a problem in conventional technologies that measurement results of a plurality of associated qubits cannot be accurately determined, so that a plurality of associated qubits may be applied.

According to a first aspect, the present disclosure provides a method for determining a measurement result of multiple qubits, a plurality of sequentially arranged qubits and a plurality of readout data buses are disposed on a quantum chip, each readout data bus is coupled to a plurality of qubits, and the determining method includes: separately acquiring, based on a sequence number of each to-be-read qubit, a readout feedback signal of a data bus corresponding to the to-be-read qubit; acquiring quantum state information of each to-be-read qubit based on the corresponding readout feedback signal; separately acquiring a quantum state measurement value of each to-be-read qubit based on the corresponding quantum state information and a readout criterion of the to-be-read qubit, where the readout criterion is used to identify a quantum state of the corresponding to-be-read qubit, and the quantum state includes a first quantum state and a second quantum state; and determining a measurement result target value of to-be-read qubits based on an information weight and the quantum state measurement value of each to-be-read qubit, where the information weight of each to-be-read qubit is determined based on the sequence number of the to-be-read qubit and a quantity of to-be-read qubits.

The present disclosure further provides a method and an apparatus for optimizing a parameter of a plurality of qubits readout signal, and a quantum computer, to solve a defect and a deficiency in a conventional technology. A parameter of a readout signal of associated multiple qubits may be optimized to ensure accuracy of a measurement result, so that a plurality of qubits may be applied.

According to a second aspect, the present disclosure provides a method for optimizing a parameter of a plurality of qubits readout signal, a plurality of sequentially arranged qubits and a plurality of readout data buses are disposed on a quantum chip, each readout data bus is coupled to a plurality of qubits, and the method for optimizing a parameter includes: separately setting a parameter of a readout signal corresponding to each to-be-read qubit based on the to-be-read qubit, where to-be-read qubits located on a same readout data bus have a same readout signal, the readout signal is obtained based on mixing of intermediate frequency signals, and the intermediate frequency signal includes modulation and coding information required by a qubit for quantum computing; separately applying the readout signal to a corresponding readout data bus to obtain a corresponding readout feedback signal; acquiring measurement data of each to-be-read qubit based on the readout feedback signal, where the measurement data is scatter point data in an IQ coordinate system; and separately optimizing, based on a distribution feature of measurement data of each to-be-read qubit in the IQ coordinate system, the parameter of the readout signal corresponding to each to-be-read qubit.

According to a third aspect, the present disclosure provides an apparatus for determining a measurement result of multiple qubits, including: a first acquisition module, configured to acquire a sequence number of each to-be-read qubit and a quantity of to-be-read qubits; a second acquisition module, configured to separately acquire, based on a sequence number of each to-be-read qubit, a readout feedback signal of a data bus corresponding to the to-be-read qubit; a third acquisition module, configured to acquire quantum state information of each to-be-read qubit based on the corresponding readout feedback signal; a fourth acquisition module, configured to separately acquire a quantum state measurement value of each to-be-read qubit based on the corresponding quantum state information and a readout criterion of the to-be-read qubit; and a determining module, configured to determine a measurement result target value of to-be-read qubits based on an information weight and the quantum state measurement value of each to-be-read qubit.

According to a fourth aspect, the present disclosure provides an apparatus for optimizing a parameter of a multi-qubit readout signal, including: a setting module, configured to separately set a parameter of a readout signal corresponding to each to-be-read qubit based on the to-be-read qubit; an application module, configured to separately apply the readout signal to a corresponding readout data bus to obtain a corresponding readout feedback signal; an acquisition module, configured to acquire measurement data of each to-be-read qubit based on the corresponding readout feedback signal; and an optimization module, configured to separately optimize, based on a distribution feature of the measurement data of each to-be-read qubit in the IQ coordinate system, the parameter of the readout signal corresponding to the to-be-read qubit.

According to a fifth aspect, the present disclosure provides a quantum computer, to which the method for determining a measurement result of multiple qubits according to the first aspect or the method for optimizing a parameter of a multi-qubit readout signal according to the second aspect is applied, or including the apparatus for determining a measurement result of multiple qubits according to the third aspect or the apparatus for optimizing a parameter of a multi-qubit readout signal according to the fourth aspect.

In an embodiment, measurement results of a plurality of associated qubits may be determined, so that the plurality of associated qubits may be applied, practicality of the plurality of associated qubits is improved, and an application scenario of the plurality of associated qubits is expanded.

In another embodiment, a parameter of a readout signal of associated multiple qubits may be optimized to ensure accuracy of a measurement result, so that the plurality of associated qubits may be applied, practicality of the plurality of associated qubits is improved, and an application scenario of the plurality of associated qubits is expanded.

### BRIEF DESCRIPTION OF THE DRAWINGS

To describe the technical solutions in the embodiments of the present disclosure or in the conventional technology more clearly, the following briefly describes the accompanying drawings required for describing the embodiments or the conventional technology. Apparently, the accompanying drawings in the following description only show some embodiments of the present disclosure, and a person of ordinary skill in the art may still derive other drawings from these accompanying drawings without creative efforts.

FIG. 1 is a hardware structural block diagram of a computer terminal for implementing a method for determining a measurement result of multiple qubits according to an embodiment of the present disclosure.

FIG. 2 is a schematic structural diagram of a superconducting quantum chip according to an embodiment of the present disclosure.

FIG. 3 is a schematic flowchart of a method for determining a measurement result of multiple qubits according to an embodiment of the present disclosure.

FIG. 4 is a schematic structural diagram of a 24-bit quantum chip according to an embodiment of the present disclosure.

FIG. 5 is a schematic flowchart of a method for determining a measurement result target value of to-be-read qubits based on each to-be-read qubit information weight and a quantum state measurement value according to an embodiment of the present disclosure.

FIG. 6 is a schematic flowchart of a method for determining a measurement result target value of to-be-read qubits based on a measurement result eigenvalue and a corrected probability matrix according to an embodiment of the present disclosure.

FIG. 7 is a schematic flowchart of a method for determining a union fidelity matrix based on a sequence number of each to-be-read qubit and a fidelity matrix according to an embodiment of the present disclosure.

FIG. 8 is a schematic flowchart of a method for correcting a probability matrix of measurement result eigenvalues based on a union fidelity matrix according to an embodiment of the present disclosure.

FIG. 9 is a block diagram of an apparatus for determining a measurement result of multiple qubits according to an embodiment of the present disclosure.

FIG. 10 is a schematic flowchart of a method for optimizing a parameter of a multi-qubit readout signal according to an embodiment of the present disclosure.

FIG. 11 is a distribution pattern in an IQ coordinate system according to an embodiment of the present disclosure.

FIG. 12 is a schematic flowchart of a method for separately setting, based on each to-be-read qubit, a readout signal parameter corresponding to the to-be-read qubit according to an embodiment of the present disclosure.

FIG. 13 is a schematic flowchart of a method for separately optimizing, based on a distribution feature of measurement data of each to-be-read qubit in an IQ coordinate system, a parameter of a readout signal corresponding to the to-be-read qubit according to an embodiment of the present disclosure.

FIG. 14 is a block diagram of an apparatus for optimizing a parameter of a multi-qubit readout signal according to an embodiment of the present disclosure.

### DETAILED DESCRIPTION OF THE EMBODIMENTS

The following further describes in detail a method and an apparatus for determining a measurement result of multiple qubits, and a quantum computer proposed in the present disclosure with reference to the accompanying drawings and specific embodiments. The advantages and features of the present disclosure will be more apparent from the following description. It should be noted that, the accompanying drawings all use a very simplified form and a non-accurate proportion for conveniently and clearly assisting in description of the embodiments of the present disclosure.

In the description of the present disclosure, the terms “first” and “second” are merely intended for a purpose of description, and shall not be understood as an indication or implication of relative importance or implicit indication of the number of indicated technical features. Therefore, the features defined by “first” and “second” may indicate or imply that one or more of the features are included. In the descriptions of the present disclosure, “a plurality of” means at least two, for example, two or three, unless otherwise specifically stated.

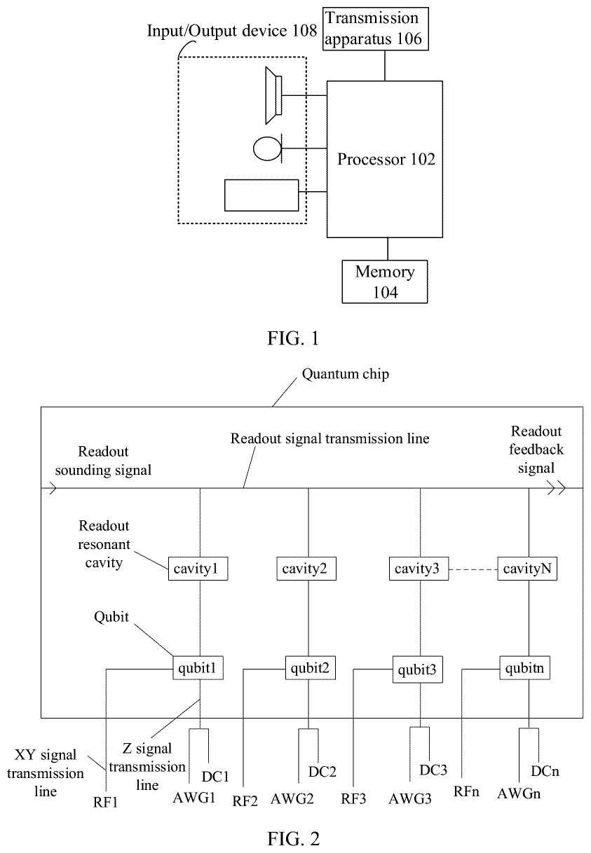

A method provided in the embodiments may be executed in a computer terminal or a similar operation apparatus. For example. a method is run on a computer terminal. Referring to FIG. 1, the computer terminal may include one or more (only one shown in FIG. 1) processors 102 (the processor 102 may include but is not limited to a processing apparatus such as a microcontroller unit (Microcontroller Unit, MCU) or a programmable gate array (Field Programmable Gate Array, FPGA)) and a memory 104 configured to store data. Optionally, the computer terminal may further include a transmission apparatus 106 and an input/output device 108 for implementing a communications function. A person of ordinary skill in the art may understand that the structure shown in FIG. 1 is merely an example and does not constitute any limitation on a structure of the computer terminal. For example, the computer terminal may alternatively include more or fewer components than those shown in FIG. 1, or have a configuration different from that shown in FIG. 1.

The memory 104 may be configured to store a software program and a module of application software, for example, a program instruction/module corresponding to a method for determining a measurement result of multiple qubits or a method for optimizing a parameter of a readout signal of a plurality of qubits provided in the present application. The processor 102 executes various function applications and data processing by running the software program and the module that are stored in the memory 104, that is, implements the foregoing method. The memory 104 may include a high-speed random access memory, and may further include a non-volatile solid-state memory. In some embodiments, the memory 104 may further include a memory 104 remotely disposed relative to the processor 102, which may be connected to a computer terminal over a network. Examples of the network include but are not limited to the Internet, a corporate intranet, a local area network, a mobile communication network, and a combination thereof.

The transmission apparatus 106 is configured to receive or send data over a network. A specific example of the network may include a wireless network provided by a communication provider of a computer terminal. In an embodiment, the transmission apparatus includes a network interface controller (Network Interface Controller, NIC) that may be connected to another network device by using a base station, so as to communicate with the Internet. In an embodiment, the transmission apparatus 106 may be a radio frequency (Radio Frequency, RF) module. The radio frequency module is configured to communicate with the Internet in a wireless manner.

The method provided in the embodiments may be applied to the foregoing computer terminal, which is also referred to as a quantum computer.

In the quantum computer, a quantum chip is a processor for executing quantum computing. Referring to FIG. 2. a quantum chip is integrated with a plurality of qubits and a plurality of readout resonant cavities that are in a one-to-one correspondence and mutually coupled with each other. A terminal, away from a corresponding qubit, of each readout resonant cavity is connected to a readout signal transmission line integrated on the quantum chip. Each qubit is coupled with an XY signal transmission line and a Z signal transmission line. The XY signal transmission line is configured to receive a quantum state control signal. The Z signal transmission line is configured to receive a magnetic flux control signal. The magnetic flux control signal includes a bias voltage signal and/or a pulse bias control signal. Both the bias voltage signal and the pulse bias control signal may regulate a frequency of the qubit. The readout signal transmission line is configured to receive a readout sounding signal and transmit a readout feedback signal.

Control and processing processes of qubits are described as follows.

A frequency of a qubit is adjusted to an operating frequency by using a magnetic flux control signal on the Z signal transmission line. In this case, a quantum state control signal is applied by using the XY signal transmission line to perform quantum state control on a qubit that is in an initial state. A quantum state of the qubit obtained after the control is read out by using a readout resonant cavity. Specifically, a readout signal transmission line is used to apply a carrier pulse signal, which is generally referred to as a readout sounding signal. The readout sounding signal is generally a microwave signal with a frequency ranging from 4 GHz to 8 GHz. The quantum state of the qubit is determined by parsing a readout feedback signal output by the readout signal transmission line. A reason why a readout resonant cavity can read a quantum state of a qubit is that different quantum states of the qubit have different dispersion shifts to the readout resonant cavity, so that different quantum states of the qubit have different responses to a readout sounding signal applied to the readout resonant cavity. The response signal is referred to as a readout feedback signal. Only when a carrier frequency of the readout sounding signal of the qubit is very close to a natural frequency (also referred to as a resonance frequency) of the readout resonant cavity, the readout resonant cavity has an obviously different response to the readout sounding signal due to different quantum states of the qubit, that is, the readout feedback signal has a maximum distinguishability. Based on this, a quantum state in which the qubit is located is determined by parsing a readout feedback signal of a specific pulse length. For example, a readout feedback signal collected each time is converted into a coordinate point in an orthogonal plane coordinate system (namely, an I-Q plane coordinate system). It is determined, based on a position of the coordinate point, whether a corresponding quantum state is state |0 [symbol] or state |1 [symbol] . It may be understood that the state |0 [symbol] and state |1 [symbol] are two eigenstates of a qubit.

The present disclosure provides a method and an apparatus for determining a measurement result of multiple qubits, and a quantum computer, to determine measurement results of a plurality of associated qubits, so that the plurality of associated qubits may be applied, practicality of the plurality of associated qubits is improved, and application scenarios of the plurality of associated qubits are expanded.

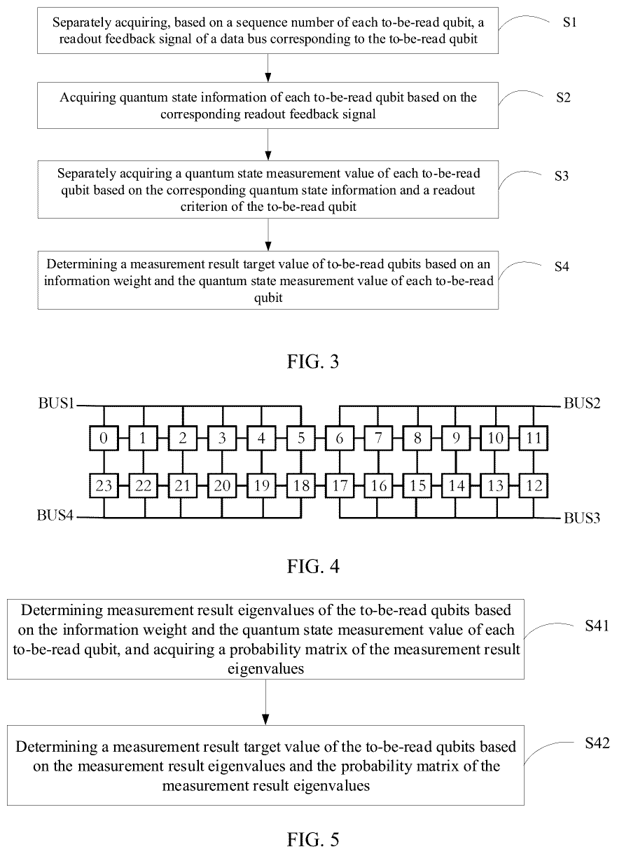

Therefore, the embodiment provides a method for determining a measurement result of multiple qubits. A plurality of sequentially arranged qubits and a plurality of readout data buses are disposed on a quantum chip, and each readout data bus is coupled to a plurality of qubits. Referring to FIG. 3, the method includes the following steps.
Step S1: Separately acquiring, based on a sequence number of each to-be-read qubit, a readout feedback signal of a readout data bus corresponding to the to-be-read qubit.

For example, parameters of readout signals of a plurality of qubits may be optimized. Parameters of readout signals of a plurality of associated qubits may be optimized to ensure accuracy of measurement results, so that the plurality of associated qubits may be applied, practicality of the plurality of associated qubits is improved, and an application scenario of the plurality of associated qubits is expanded. Referring to FIG. 10, the parameter optimization method includes the following steps.
Step S21: Separately setting a parameter of a readout signal corresponding to each to-be-read qubit based on the to-be-read qubit.

Readout signals of to-be-read qubits located on a same readout data bus have a same local oscillator signal. The readout signals are obtained by mixing an intermediate frequency signal with the local oscillator signal. The intermediate frequency signal includes modulation and coding information required by qubits for quantum computing.

According to an embodiment, a sequence number of each to-be-read qubit and a quantity of to-be-read qubits are acquired. For example, a size of 24-bit quantum chip is used as an example. Referring to FIG. 4, 24 qubits arranged in sequence and four readout data buses (BUS) are disposed on the 24-bit quantum chip. A specific arrangement sequence of the 24 qubits is shown in FIG. 4. Each readout data bus is coupled with six qubits. A specific connection relationship is that a readout data bus BUS1 is coupled with qubits with sequence numbers 0-5, a readout data bus BUS2 is coupled with qubits with sequence numbers 6-11, a readout data bus BUS3 is coupled with qubits with sequence numbers 12-17, and a readout data bus BUS4 is coupled with qubits with sequence numbers 18-23. For example, an experiment is performed based on the 24-bit quantum chip. For example, three to-be-read qubits are acquired, and sequence numbers are respectively 0, 1, and 17. The three to-be-read qubits are respectively recorded as Q₀, Q₁, and Q₁₇.
Step S22: Separately applying the readout signal to a corresponding readout data bus to obtain a corresponding readout feedback signal.

In this embodiment, it may be learned from the foregoing description that, when a read operation is performed, readout signals corresponding to two to-be-read qubits Q₀ and Q₁ are applied to the readout data bus BUS1 to acquire corresponding readout feedback signals; and a readout signal corresponding to the to-be-read qubit Q₁₇ is applied to the readout data bus BUS3 to acquire a corresponding readout feedback signal.

It may be learned from the foregoing description that the readout data bus corresponding to the two to-be-read qubits Q₀ and Q₁ is BUS1, and a readout data bus corresponding to the to-be-read qubit Q₁₇ is BUS3. Correspondingly, readout feedback signals of the readout data buses BUS1 and BUS3 are acquired.
Step S23: Acquiring measurement data of each to-be-read qubit based on the corresponding readout feedback signal.

The readout feedback signal is an analog signal, representing a signal of quantum state information for a to-be-read qubit coupled thereto. The measurement data that can represent each piece of quantum state information may be obtained by applying different carrier pulse signals (read sounding signals) to a corresponding to-be-read qubit and repeating the process, where the measurement data is scatter point data in an IQ coordinate system.
Step S24: Separately optimizing, based on a distribution feature of measurement data of each to-be-read qubit in the IQ coordinate system, the parameter of the readout signal corresponding to the to-be-read qubit.

Theoretically, in an ideal case, the measurement data obtained by applying different carrier pulse signals (read sounding signals) to a corresponding to-be-read qubit and repeating the process is distributed in the IQ coordinate system into two circular spots, which respectively represent two different ground states of the to-be-read qubits, to be specific, state |0 [symbol] and state |1 [symbol] . However, after a large quantity of repeated experiments, it is found that in a measurement process, the obtained measurement data is distributed in the IQ coordinate system into two quasi-circles, as shown in FIG. 11. It may be found that a small part of measurement data corresponding to the state |0 [symbol] in the figure is distributed in the measurement data of the state |1 [symbol] ; and a small part of measurement data corresponding to state |1 [symbol] in the figure is distributed in the measurement data of the state |0 [symbol] . This indicates that there is a case in the experiment that destroys distribution of the quantum states of the to-be-read qubits. Therefore, a parameter of a corresponding readout signal needs to be optimized, to make distribution of the quantum states of the to-be-read qubits more idealized.
Step S2: Acquiring quantum state information of each to-be-read qubit based on the corresponding readout feedback signal.

The readout feedback signal is obtained from a readout data bus, and represents a signal of quantum state information for a to-be-read qubit coupled to the readout data bus. It should be noted that, the readout feedback signal is an analog signal, and a form of the analog signal includes but is not limited to: S=Acos(ωt+φ)=A/2[e^{-i(ωt+φ)}+e^{i(ωt+φ)}]. A person skilled in the art may understand that the form is a general representation of the analog signal, and therefore, parameters in the formula are not described herein. Digital processing, including but not limited to frequency mixing and/or integration processing, is performed on the signal to obtain corresponding complex signal that includes quantum state information. In this embodiment, quantum state information of two to-be-read qubits Q₀ and Q₁ may be obtained based on the readout feedback signal obtained from the readout data bus BUS1. Quantum state information of the to-be-read qubit Q₁₇ may be obtained based on the readout feedback signal obtained from the readout data bus BUS3.
Step S3: Separately acquiring a quantum state measurement value of each to-be-read qubit based on the corresponding quantum state information and a readout criterion of the to-be-read qubit.

It should be noted that the readout criterion is obtained by means of machine training. A specific training process is as follows.

A carrier pulse signal (readout sounding signal) is applied to a to-be-trained qubit, and a readout feedback signal output by a readout data bus corresponding to the to-be-trained qubit is measured to obtain corresponding quantum state information and the corresponding quantum state information is recorded. Different carrier pulse signals (read sounding signals) are applied and the process is repeated, to obtain a measurement result that can represent each piece of quantum state information, and the readout criterion is generated based on the measurement result, to subsequently identify a quantum state of a corresponding to-be-read qubit. The quantum state includes a first quantum state and a second quantum state. In this embodiment, the first quantum state and the second quantum state are respectively state |0 [symbol] and state |1 [symbol] .

In a specific application, as long as the obtained quantum state information is input into the readout criterion, a quantum state measurement value of a corresponding to-be-read qubit may be acquired, so as to implement a quantum state identification process of the to-be-read qubit, thereby reducing of quantum computing steps and improving quantum computation efficiency.

For example, the readout criterion is one of a linear straight line equation or a curve equation.
Step S4: Determining a measurement result target value of to-be-read qubits based on an information weight and the quantum state measurement value of each to-be-read qubit.

For example, the information weight of each to-be-read qubit is determined based on a sequence number of the to-be-read qubit and a quantity of to-be-read qubits. In this embodiment, an order of a bit position of each to-be-read qubit is set to be corresponding to a size of sequence number of the to-be-read qubit. For example, a measurement result formed by three to-be-read qubits Q₀, Q₁, and Q₁₇ is Q₁₇ Q₁ Q₀. Then, the measurement result is converted into measurement result eigenvalues. Finally, a measurement result eigenvalue with a largest occurrence probability in the measurement result eigenvalues is used as the measurement result target value of the to-be-read qubits.

For example, referring to FIG. 5, the determining a measurement result target value of to-be-read qubits based on an information weight and the quantum state measurement value of each to-be-read qubit specifically includes the following steps.
Step S41: Determining measurement result eigenvalues of the to-be-read qubits based on the information weight and the quantum state measurement value of each to-be-read qubit, and acquiring a probability matrix of the measurement result eigenvalues.

In this embodiment, according to the foregoing description, the measurement result formed by the three to-be-read qubits Q₀, Q₁, and Q₁₇ is Q₁₇ Q₁ Q₀, and the measurement result is converted into measurement result eigenvalues, with a total of eight values ranging from |000 [symbol] to |111 [symbol] .

After a plurality of measurements, a probability value of occurrence of the measurement result eigenvalues |000 [symbol] , |001 [symbol] , . . . , |111 [symbol] is collected, and the eight probability values form a probability matrix of 8*1, which is denoted as M.
Step S42: Determining a measurement result target value of the to-be-read qubits based on the measurement result eigenvalues and the probability matrix of the measurement result eigenvalues.

For example, a maximum value in the probability matrix is determined, and a measurement result eigenvalue corresponding to the maximum value is used as the measurement result target value of the to-be-read qubits.

For example, after the acquiring a probability matrix of the measurement result eigenvalues, the method further includes the following steps.
Step S411: Determining a union fidelity matrix based on the sequence number and a fidelity of the readout criterion of each to-be-read qubit.

In the foregoing description of the training process of the readout criterion, fidelity values of the readout criterion may be simultaneously obtained after a large quantity of experiments. Fidelity is a parameter that represents a degree of similarity between an input signal and an output signal obtained by reproducing the input signal and output by an electronic device. In the field of quantum measurement and control and quantum computing, the higher the fidelity, the more accurate the results of quantum measurement and control and quantum computing. In this embodiment, the fidelity of the readout criterion is a probability value of quantum state measurement values of a corresponding to-be-read qubit obtained when the acquired quantum state information is input into the readout criterion.

The union fidelity matrix may then be determined based on the sequence number and the fidelity of the readout criterion of each to-be-read qubit. It is not difficult to understand that a size of the union fidelity matrix is the same as a size of the foregoing probability matrix, that is, the two matrices have same quantity of rows and columns. Numerical values in the union fidelity matrix represent theoretical probability values of occurrence of measurement result eigenvalues based on the fidelity of the readout criterion of each to-be-read qubit. For example, in this embodiment, fidelity of a readout criterion of a to-be-read qubit Q₀ is 0.9 (a quantum state of Q₀ is state |0 [symbol] ), fidelity of a readout criterion of a to-be-read qubit Q₁ is 0.3 (a quantum state of Q₁ is state |0 [symbol] ), and fidelity of a readout criterion of a to-be-read qubit Q₁₇ is 0.8 (a quantum state of Q₁₇ is state |0 [symbol] ). An acquired theoretical probability value of occurrence of a measurement result eigenvalue |000 [symbol] of the measurement result Q₁₇ Q₁ Q₀ may be 0.216 (0.9*0.3*0.8). Similarly, theoretical probability values of occurrence of remaining measurement result eigenvalues may be separately acquired. Then, theoretical probability values of occurrence of the eight measurement result eigenvalues form a union fidelity matrix of 8*1, which is denoted as F.
Step S412: Correcting the probability matrix of the measurement result eigenvalues based on the union fidelity matrix.

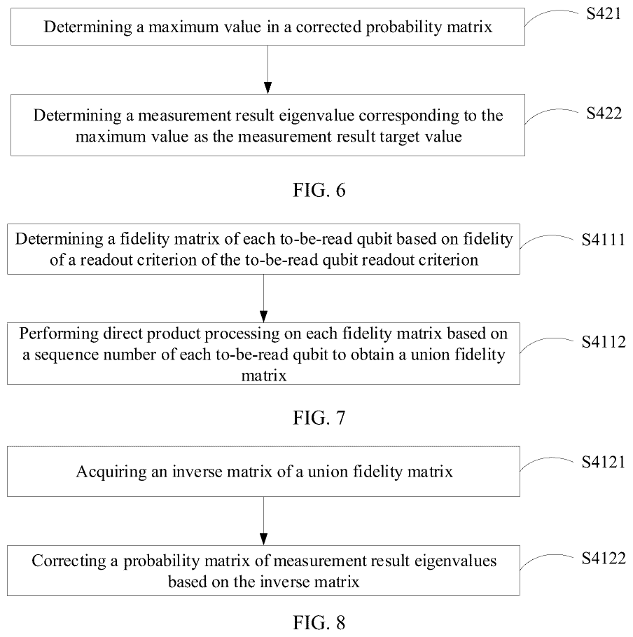

For example, the determining a measurement result target value of the to-be-read qubits based on the measurement result eigenvalues and the probability matrix of the measurement result eigenvalues includes: determining the measurement result target value of the to-be-read qubits based on the measurement result eigenvalue and a corrected probability matrix. Referring to FIG. 6, more specifically, the following steps are included.
Step S421: Determining a maximum value in the corrected probability matrix.
Step S422: Determining a measurement result eigenvalue corresponding to the maximum value as the measurement result target value.

In this embodiment, after the probability matrix is corrected, a contingency error of each probability value in the original probability matrix may be eliminated, so that each probability value in the corrected probability matrix is more accurate, and the measurement result target value obtained is more accurate.

For example, referring to FIG. 7, the determining a union fidelity matrix based on the sequence number and a fidelity matrix of each to-be-read qubit specifically includes the following steps.
Step S4111: Determining the fidelity matrix of each to-be-read qubit based on the fidelity of the readout criterion of the to-be-read qubit readout criterion.

First, the fidelity of the readout criterion of each to-be-read qubit is acquired. Then, an error rate of the readout criterion of each to-be-read qubit is determined based on the fidelity. Finally, a fidelity matrix of the readout criterion of each to-be-read qubit is determined based on the fidelity and the error rate. For example, an acquired fidelity of the readout criterion of a to-be-read qubit Q₀ is 0.9 (a quantum state of Q₀ is state |0 [symbol] ). The error rate of the readout criterion of the to-be-read qubit Q₀ is 0.1 (a quantum state of Q₀ is not state |0 [symbol] ), and it may be determined that a fidelity matrix of a readout criterion of the to-be-read qubit Q₀ is a one-row two-column fidelity matrix formed by the fidelity of the readout criterion and the error rate of the readout criterion of the to-be-read qubit Q₀. Similarly, a fidelity matrix of a readout criterion of another to-be-read qubit may be obtained.
Step S4112: Performing direct product processing on each fidelity matrix based on the sequence number of each to-be-read qubit to obtain the union fidelity matrix.

The fidelity and the error rate of the readout criterion of each to-be-read qubit may be learned based on the fidelity matrix of the readout criterion of the to-be-read qubit. Then, the union fidelity matrix may be obtained by performing direct product processing on the fidelity of the readout criterion or the error rate of the to-be-read qubit based on the sequence number and measurement result eigenvalues of each to-be-read qubit. For example, one measurement result eigenvalue of the measurement result Q₁₇ Q₁ Q₀ is |000 [symbol] . A value of the union fidelity matrix may be obtained by performing direct product processing on fidelity of readout criterion of the three to-be-read qubits Q₀, Q₁, and Q₁₇. Similarly, other values of the union fidelity matrix may be obtained.

For example, referring to FIG. 8, the correcting the probability matrix of the measurement result eigenvalues based on the union fidelity matrix specifically includes the following steps.
Step S4121: Acquiring an inverse matrix of the union fidelity matrix.
Step S4122: Correcting the probability matrix of the measurement result eigenvalues based on the inverse matrix.

For example, during obtaining of the probability matrix of the measurement result eigenvalues, a random error may occur, and an actual measurement result frequency value is affected, which may be corrected by using the following formula:
M′=F⁻¹. M, where M′ is a corrected probability matrix of measurement result eigenvalues, and F⁻¹ is an inverse matrix of F.

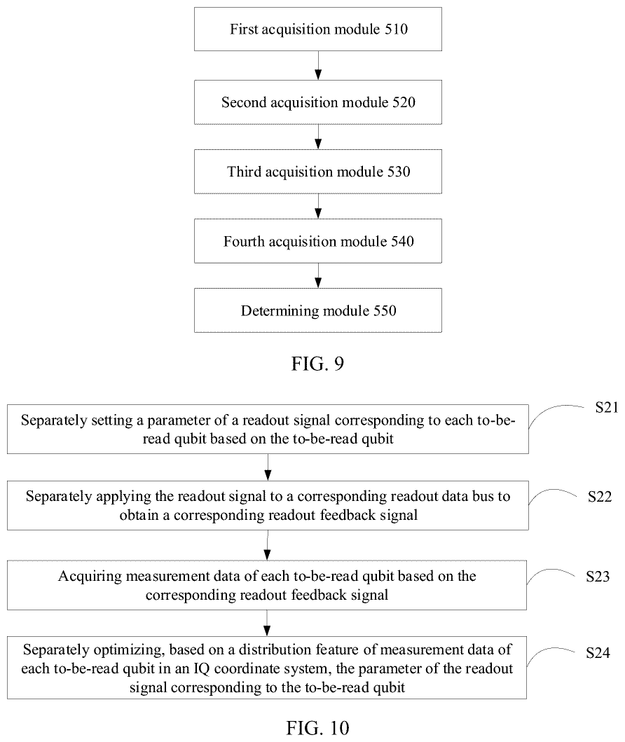

Based on a same application concept, the embodiment further provides an apparatus for determining a measurement result of multiple qubits. Referring to FIG. 9, the determining apparatus includes the following modules.

A first acquisition module 510, configured to acquire a sequence number of each to-be-read qubit and a quantity of to-be-read qubits;

A second acquisition module 520, configured to separately acquire, based on a sequence number of each to-be-read qubit, a readout feedback signal of a data bus corresponding to the to-be-read qubit;

A third acquisition module 530, configured to acquire quantum state information of each to-be-read qubit based on the corresponding readout feedback signal;

A fourth acquisition module 540, configured to separately acquire a quantum state measurement value of each to-be-read qubit based on the corresponding quantum state information and a readout criterion of the to-be-read qubit; and

A determining module 550, configured to determine a measurement result target value of to-be-read qubits based on an information weight and the quantum state measurement value of each to-be-read qubit.

In addition, based on a same application concept, an embodiment further provides a quantum computer, configured to perform quantum computing by using the foregoing method for determining a measurement result of multiple qubits, or including the foregoing apparatus for determining a measurement result of multiple qubits.

In conclusion, measurement results of a plurality of associated qubits may be determined, so that the plurality of associated qubits may be applied, practicality of the plurality of associated qubits is improved, and an application scenario of the plurality of associated qubits is expanded.

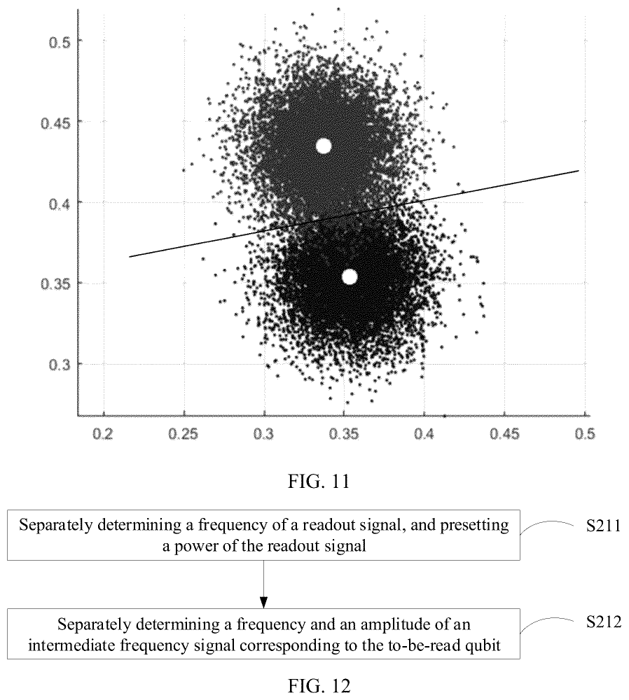

For example, referring to FIG. 12, the separately setting a parameter of a readout signal corresponding to each to-be-read qubit based on the to-be-read qubit includes the following steps.
Step S211: Separately determining a frequency of the readout signal, and presetting a power of the readout signal.

When the frequency of the readout signal is separately determined, readout frequencies of all qubits coupled to a readout data bus corresponding to each to-be-read qubit may be separately obtained. Then the frequency of the corresponding readout signal is separately determined based on the readout frequencies of all qubits on the readout data bus. A median bit of the readout frequencies of the qubits may be separately determined based on the readout frequencies of all qubits on the readout data bus, and then the median bit of the readout frequencies of the qubits is set to a frequency of a readout signal of a corresponding readout data bus. For example, in this embodiment, setting of a frequency of a readout signal corresponding to the to-be-read qubit Q₁₇ is used as an example. First, readout frequencies of all qubits (that is, qubits with sequence numbers of 12 to 17) coupled to a readout data bus of the to-be-read qubit Q₁₇ is acquired, then the six readout frequencies are arranged in a sequence of values, and an average value of two values in the middle is obtained as the frequency of the readout signal corresponding to the to-be-read qubit Q₁₇
Step S212: Separately determining a frequency and an amplitude of an intermediate frequency signal corresponding to the to-be-read qubit.

When the frequency of the intermediate frequency signal corresponding to the to-be-read qubit is separately determined, the frequency of the intermediate frequency signal corresponding to the to-be-read qubit may be separately determined based on a first preset relationship. The frequency of the intermediate frequency signal corresponding to the to-be-read qubit, the frequency of the readout signal, a readout frequency corresponding to the to-be-read qubit, and a preset frequency of the intermediate frequency signal meet the first preset relationship. For example, the first preset relationship is If′=Fc-Fc′+If, where If is a frequency of the intermediate frequency signal corresponding to the to-be-read qubit, Fc is a frequency of the readout signal, Fc′ is a readout frequency corresponding to the corresponding to-be-read qubit, and If is a preset frequency of the intermediate frequency signal.

When an amplitude of the intermediate frequency signal corresponding to the to-be-read qubit is separately determined, the amplitude of the intermediate frequency signal corresponding to the to-be-read qubit may be separately determined based on a second preset relationship. The amplitude of the intermediate frequency signal corresponding to the to-be-read qubit, a preset amplitude of the intermediate frequency signal, the power of the readout signal, and a readout power corresponding to the to-be-read qubit meet the second preset relationship. For example, the second preset relationship is: Amp′=Amp×10\hat{ }[(Pc′−10 dB−Pc)/2], where Amp′ is an amplitude of the intermediate frequency signal corresponding to the to-be-read qubit, Amp is a readout waveform amplitude corresponding to the to-be-read qubit, Pc′ is a power of the readout signal, and Pc is a readout power corresponding to the to-be-read qubit.

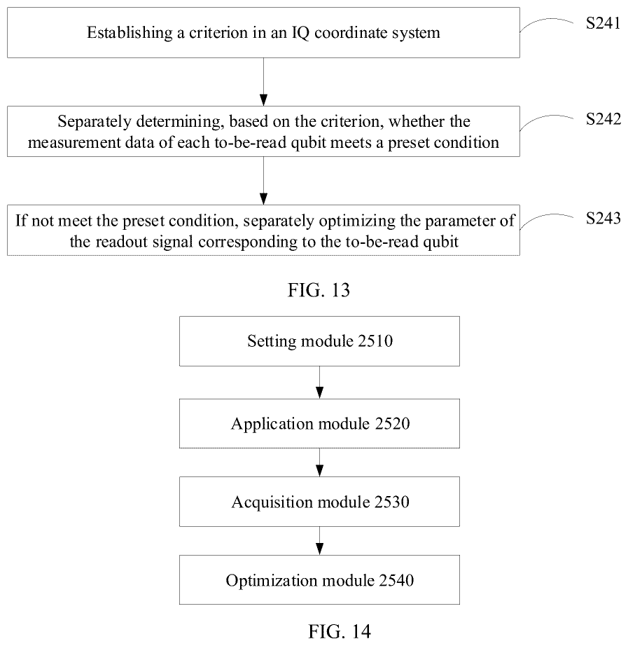

For example, referring to FIG. 13, the separately optimizing, based on a distribution feature of measurement data of each to-be-read qubit in the IQ coordinate system, the parameter of the readout signal corresponding to each to-be-read qubit specifically includes the following steps.
Step S241: Establishing a criterion in the IQ coordinate system.

Preferably, the criterion is a straight line represented as I=Q in the IQ coordinate system. For example, the criterion is used to reflect a distribution feature of measurement data of each to-be-read qubit in the IQ coordinate system.
Step S242: Separately determining, based on the criterion, whether measurement data of each to-be-read qubit meets a preset condition.

If the measurement data of each to-be-read qubit does not meet the preset condition, Step S243 is performed, that is, separately optimizing the parameter of the readout signal corresponding to each to-be-read qubit.

For example, the preset condition includes a first preset condition, and whether measurement data of each to-be-read qubit meets the preset condition is determined based on the criterion. If the measurement data of each to-be-read qubit does not meet the preset condition, the separately optimizing the parameter of the readout signal corresponding to the to-be-read qubit may include the following steps.

Whether the measurement data of each to-be-read qubit meets a first preset condition is separately determined based on the criterion. The first preset condition is that measurement data obtained in a measurement process is distributed in an IQ coordinate system into two stable and clear quasi-circles (namely, two stable quasi-circles) respectively located on both sides of the criterion.

If the measurement data of each to-be-read qubit does not meet the first preset condition, an amplitude of an intermediate frequency signal corresponding to the to-be-read qubit is reduced according to a preset step within a preset range and the readout signal is updated. The amplitude of the intermediate frequency signal corresponding to each to-be-read qubit ranges from 0 V to 1 V.

For example, the preset condition further includes a second preset condition. After whether the measurement data of each to-be-read qubit meets the first preset condition is separately determined based on the criterion, the following steps are further included.

If the measurement data of each to-be-read qubit meets the first preset condition, whether the measurement data of each to-be-read qubit meets a second preset condition is separately determined based on the criterion. The second preset condition is that measurement data obtained in a measurement process is distributed in the IQ coordinate system into two quasi-circles, located on both sides of the criterion, with boundaries not intersected (namely, two separated quasi-circles).

If the measurement data of each to-be-read qubit does not meet the first preset condition, a frequency of an intermediate frequency signal corresponding to the to-be-read qubit is reduced or increased according to a preset step within a preset range and the readout signal is updated.

For example, the preset condition further includes a third preset condition. After whether the measurement data of each to-be-read qubit meets the second preset condition is separately determined based on the criterion, the following steps are further included.

If the measurement data of each to-be-read qubit meets the second preset condition, whether the measurement data of each to-be-read qubit meets the third preset condition is separately determined based on the criterion. The third preset condition is that measurement data obtained in a measurement process is distributed in the IQ coordinate system into two quasi-circles with high concentration located on both sides of the criterion (namely, two quasi-circles with high fidelity).

If the measurement data of each to-be-read qubit does not meet the second preset condition, a frequency and/or an amplitude of an intermediate frequency signal corresponding to the to-be-read qubit are/is reduced or increased according to a preset step within a preset range and the readout signal is updated.

Based on a same application concept, the embodiment further provides an apparatus for optimizing a parameter of a multi-qubit readout signal. Referring to FIG. 14, the apparatus for optimizing a parameter includes the following modules:
a setting module 2510, configured to separately set a parameter of a readout signal corresponding to each to-be-read qubit based on the to-be-read qubit;
an application module 2520, configured to separately apply the readout signal to a corresponding readout data bus to obtain a corresponding readout feedback signal;
an acquisition module 2530, configured to acquire measurement data of each to-be-read qubit based on the corresponding readout feedback signal; and
an optimization module 2540, configured to separately optimize, based on a distribution feature of the measurement data of each to-be-read qubit in the IQ coordinate system, the parameter of the readout signal corresponding to the to-be-read qubit.

In addition, based on a same inventive concept, the embodiment further provides a quantum computer, configured to perform optimization of a parameter of a multi-qubit readout signal according to the method for optimizing a parameter of a multi-qubit readout signal, or including the apparatus for optimizing a parameter of a multi-qubit readout signal.

In conclusion, a parameter of a readout signal of a plurality of associated qubits may be optimized to ensure accuracy of measurement results, so that the plurality of associated qubits may be applied, practicality of the plurality of associated qubits is improved, and an application scenario of the plurality of associated qubits is expanded.

The foregoing description is merely a description of the preferred embodiments of the present disclosure, and is not intended to limit the scope of the present disclosure. Any change or modification made by a person of ordinary skill in the art according to the foregoing disclosure falls within the protection scope of the claims.

What is claimed is:

1. A method for determining a measurement result of multiple qubits, wherein a plurality of sequentially arranged qubits and a plurality of readout data buses are disposed on a quantum chip, each readout data bus is coupled to a plurality of qubits, and the method comprises:
separately acquiring, based on a sequence number of each to-be-read qubit, a readout feedback signal of a data bus corresponding to the to-be-read qubit;
acquiring quantum state information of each to-be-read qubit based on the corresponding readout feedback signal;
separately acquiring a quantum state measurement value of each to-be-read qubit based on the corresponding quantum state information and a readout criterion of the to-be-read qubit, wherein the readout criterion is used to identify a quantum state of a corresponding to-be-read qubit, and the quantum state comprises a first quantum state and a second quantum state; and
determining a measurement result target value of to-be-read qubits based on an information weight and the quantum state measurement value of each to-be-read qubit, wherein the information weight of each to-be-read qubit is determined based on the sequence number of the to-be-read qubit and a quantity of to-be-read qubits.

2. The method according to claim 1, wherein the determining a measurement result target value of to-be-read qubits based on an information weight and the quantum state measurement value of each to-be-read qubit specifically comprises:
determining measurement result eigenvalues of the to-be-read qubits based on information weight and the quantum state measurement value of each to-be-read qubit, and acquiring a probability matrix of the measurement result eigenvalues; and
determining a measurement result target value of the to-be-read qubits based on the measurement result eigenvalue and the probability matrix of the measurement result eigenvalues.

3. The method according to claim 2, after the acquiring a probability matrix of the measurement result eigenvalues, the method further comprises:
determining a union fidelity matrix based on the sequence number and fidelity of the readout criterion of each to-be-read qubit; and
correcting the probability matrix of the measurement result eigenvalues based on the union fidelity matrix.

4. The method according to claim 3, wherein the determining a measurement result target value of the to-be-read qubits based on the measurement result eigenvalues and the probability matrix of the measurement result eigenvalues comprises:
determining the measurement result target value of the to-be-read qubits based on the measurement result eigenvalues and a corrected probability matrix.

5. The method according to claim 4, wherein the determining the measurement result target value of the to-be-read qubits based on the measurement result eigenvalues and a corrected probability matrix comprises:
determining a maximum value in the corrected probability matrix; and
determining a measurement result eigenvalue corresponding to the maximum value as the measurement result target value.

6. The method according to claim 3, wherein the determining a union fidelity matrix based on the sequence number and fidelity of the readout criterion of each to-be-read qubit comprises:
determining a fidelity matrix of each to-be-read qubit based on the fidelity of the readout criterion of each to-be-read qubit readout criterion; and
performing direct product processing on each fidelity matrix based on the sequence number of each to-be-read qubit to obtain the union fidelity matrix.

7. The method according to claim 3, wherein the correcting the probability matrix of the measurement result eigenvalues based on the union fidelity matrix specifically comprises:
acquiring an inverse matrix of the union fidelity matrix; and
correcting the probability matrix of the measurement result eigenvalues based on the inverse matrix.

8. The method according to claim 6, wherein the determining a fidelity matrix of each to-be-read qubit based on the fidelity of the readout criterion of the to-be-read qubit readout criterion comprises:
acquiring the fidelity of the readout criterion of each to-be-read qubit;
determining an error rate of the readout criterion of each to-be-read qubit based on the fidelity; and
determining the fidelity matrix of the readout criterion of each to-be-read qubit based on the fidelity and the error rate.

9. The method according to claim 1, wherein the readout criterion is a linear equation or a curve equation.

10. The method according to claim 1, wherein the separately acquiring, based on a sequence number of each to-be-read qubit, a readout feedback signal of a data bus corresponding to the to-be-read qubit comprises:
separately setting a parameter of a readout signal corresponding to each to-be-read qubit based on the to-be-read qubit, wherein to-be-read qubits located on a same readout data bus have a same readout signal, the readout signal is obtained based on mixing of intermediate frequency signals, and the intermediate frequency signal comprises modulation and coding information required by a qubit for quantum computing;
separately applying the readout signal to a corresponding readout data bus to obtain a corresponding readout feedback signal;
acquiring measurement data of each to-be-read qubit based on the readout feedback signal, wherein the measurement data is scatter point data in an IQ coordinate system; and
separately optimizing, based on a distribution feature of measurement data of each to-be-read qubit in the IQ coordinate system, the parameter of the readout signal corresponding to the to-be-read qubit.

11. The method according to claim 10, wherein the separately setting a parameter of a readout signal corresponding to each to-be-read qubit based on the to-be-read qubit comprises:
separately determining a frequency of the readout signal, and presetting a power of the readout signal; and
separately determining a frequency and an amplitude of an intermediate frequency signal corresponding to the to-be-read qubit.

12. The method according to claim 11, wherein the separately determining a frequency of the readout signal comprises:
separately acquiring readout frequencies of all qubits coupled to a readout data bus corresponding to each to-be-read qubit; and
separately determining the frequency of the corresponding readout signal based on readout frequencies of all qubits on the readout data bus.

13. The method according to claim 11, wherein the separately determining a frequency and an amplitude of an intermediate frequency signal corresponding to the to-be-read qubit comprises:
separately determining, based on a first preset relationship, the frequency of the intermediate frequency signal corresponding to the to-be-read qubit, wherein the frequency of the intermediate frequency signal corresponding to the to-be-read qubit, the frequency of the readout signal, a readout frequency of the corresponding to the to-be-read qubit, and a preset frequency of the intermediate frequency signal meet the first preset relationship; and
separately determining, based on a second preset relationship, the amplitude of the intermediate frequency signal corresponding to the to-be-read qubit, wherein the amplitude of the intermediate frequency signal corresponding to the to-be-read qubit, a preset amplitude of the intermediate frequency signal, the power of the readout signal, and a readout power corresponding to the to-be-read qubit meet the second preset relationship.

14. The method according to claim 1, wherein the information weight of each to-be-read qubit is determined based on a sequence number of the to-be-read qubit and a quantity of to-be-read qubits.

15. The method according to claim 3, wherein a size of the union fidelity matrix is the same as a size of the foregoing probability matrix.

16. The method according to claim 1, wherein the readout criterion is obtained by means of machine training.

17. The method according to claim 12, wherein the separately determining the frequency of the corresponding readout signal based on readout frequencies of all qubits on the readout data bus comprises:
determining a median bit of the readout frequencies of the qubits based on the readout frequencies of all qubits on the readout data bus;
setting the median bit of the readout frequencies of the qubits to the frequency of the readout signal of a corresponding readout data bus.

18. The method according to claim 13, wherein the first preset relationship is If′=Fc−Fc′+If, If′ is a frequency of the intermediate frequency signal corresponding to the to-be-read qubit, Fc is a frequency of the readout signal, Fc′ is a readout frequency corresponding to the corresponding to-be-read qubit, and If is a preset frequency of the intermediate frequency signal.

19. An apparatus for determining a measurement result of multiple qubits, comprising a memory and a processor, wherein the memory stores a computer program, and the processor is configured to run the computer program, so that the following method is performed:
separately acquiring, based on a sequence number of each to-be-read qubit, a readout feedback signal of a data bus corresponding to the to-be-read qubit;
acquiring quantum state information of each to-be-read qubit based on the corresponding readout feedback signal;
separately acquiring a quantum state measurement value of each to-be-read qubit based on the corresponding quantum state information and a readout criterion of the to-be-read qubit, wherein the readout criterion is used to identify a quantum state of a corresponding to-be-read qubit, and the quantum state comprises a first quantum state and a second quantum state; and
determining a measurement result target value of to-be-read qubits based on an information weight and the quantum state measurement value of each to-be-read qubit, wherein the information weight of each to-be-read qubit is determined based on the sequence number of the to-be-read qubit and a quantity of to-be-read qubits.

20. A quantum computer, comprising an apparatus for determining a measurement result of multiple qubits, wherein the apparatus comprises a memory and a processor, the memory stores a computer program, and the processor is configured to run the computer program, so that the following method is performed:
separately acquiring, based on a sequence number of each to-be-read qubit, a readout feedback signal of a data bus corresponding to the to-be-read qubit;
acquiring quantum state information of each to-be-read qubit based on the corresponding readout feedback signal;
separately acquiring a quantum state measurement value of each to-be-read qubit based on the corresponding quantum state information and a readout criterion of the to-be-read qubit, wherein the readout criterion is used to identify a quantum state of a corresponding to-be-read qubit, and the quantum state comprises a first quantum state and a second quantum state; and
determining a measurement result target value of to-be-read qubits based on an information weight and the quantum state measurement value of each to-be-read qubit, wherein the information weight of each to-be-read qubit is determined based on the sequence number of the to-be-read qubit and a quantity of to-be-read qubits.
